(19) United States
(12) Patent Application Publication
(10) Pub. No.: US 2012/0325349 A1
(43) Pub. Date: Dec. 27, 2012

(54) SUBSTRATE ACCOMMODATION DEVICE

(75) Inventor: Tsuyoshi Moriya, Tokyo (JP)

(73) Assignee: TOKYO ELECTRON LIMITED, Tokyo (JP)

(21) Appl. No.: 13/582,079

(22) PCT Filed: Feb. 21, 2011
(86) PCT No.: PCT/JP2011/000942

§ 371 Date: Aug. 31, 2012

(30) Foreign Application Priority Data
Mar. 4, 2010 (JP) 2010-048380

(51) Int. Cl. F17D 3/00

(52) U.S. Cl. 137/565.17

(57) ABSTRACT

A substrate accommodation device can effectively prevent a foreign substance from adhering to a substrate accommodated therein depending on an environment where the substrate accommodation device is used. The substrate accommodation device 100 includes an air supply unit 110 configured to introduce exterior air into the substrate accommodation device 100; an exhaust unit 120 disposed to face the air supply unit 110; a substrate mounting plate 140 provided between the air supply unit 110 and the exhaust unit 120 and provided with holes 142 through which the air supply unit 110 and the exhaust unit 120 communicate with each other; an air supply filter 112 provided at the air supply unit 110; and a fan 122 provided at the air supply unit 110 or the exhaust unit 120. Further, one of a state sensor configured to detect a state within the substrate accommodation device 100, a particle charging device, and a temperature controller or a combination of two or more thereof is detachably provided in a mounting hole 150. (FIG. 2)

### TECHNICAL FIELD

The present disclosure relates to a substrate accommodation device for accommodating and transferring a substrate such as a mask blank.

### BACKGROUND ART

In order to form a fine circuit pattern on a semiconductor wafer or a FPD substrate, there has been known a lithography technology using a photomask. In this lithography technology, a substrate such as a semiconductor wafer having thereon a resist film is exposed to an electromagnetic wave outputted from an exposure light source through a photomask having a predetermined circuit pattern. As a result, the predetermined circuit pattern of the photomask is transferred and shrunk onto the semiconductor wafer.

Such a photomask is manufactured by forming the fine circuit pattern through repeatedly performing various processes such as a film formation, a chemical mechanical polishing (CMP), and a cleaning on a surface of a substrate called a mask blank. The mask blank is prepared by forming a light blocking film on a transparent substrate. If a foreign substance such as a particle exists on the surface of the mask blank, it would cause a defect in a pattern to be formed. Thus, it is required to keep the mask blank clean not to allow the foreign substance or the like to adhere to the surface of the mask blank.

Patent Documents 1 and 2 describe an accommodation vessel for storing and transferring the mask blank cleanly. In the accommodation vessel described in Patent Document 1, a ventilator having a filter is provided at the corner of the accommodation vessel in order to prevent a foreign substance contained in the exterior air from being introduced into the accommodation vessel. As for the accommodation vessel described in Patent Document 2, in order to prevent aging of a surface of a photomask or the like, an inert gas is diffused through a diffusion plate, and then, introduced into the accommodation vessel and exhausted.

Patent Document 1: Japanese Patent Laid-open Publication No. 2005-043796

Patent Document 2: Japanese Patent Laid-open Publication No. 2001-053136

### DISCLOSURE OF THE INVENTION

### Problems to Be Solved by the Invention

In the conventional accommodation vessels, however, using the ventilator having the filter or diffusing and introducing the inert gas into the accommodation vessel may not be a sufficient solution against the problem of foreign substances depending on the environment (e.g., cleanness, room temperature, dryness, etc.) where the accommodation vessels are used.

By way of example, even in the accommodation vessel described in Patent Document 1, depending on the environment where the accommodation vessel is used, a minute foreign substance passing through the filter of the ventilator may adhere to the mask blank. Further, even in the accommodation vessel described in Patent Document 2, since the accommodation vessel should be opened when the mask blank is taken out of the accommodation vessel, the foreign substance may be introduced into the accommodation vessel from the outside and adhere to the mask blank depending on the environment where the accommodation vessel is used.

Recently, as circuit patterns are getting more miniaturized, a cleanness degree required for storing and transferring the mask blank is also getting higher. For this reason, in order to prevent the foreign substance from adhering to the mask blank within the accommodation vessel, a difference in environments where the accommodation vessel is used can be no more neglected.

In view of the foregoing problems, the illustrative embodiment provides a substrate accommodation device. The substrate accommodation device can effectively prevent a foreign substance from adhering to a substrate accommodated in the substrate accommodation device depending on the environment where the substrate accommodation device is used.

### Means for Solving the Problems

In accordance with one aspect of an illustrative embodiment, there is provided a substrate accommodation device for accommodating a substrate therein. The substrate accommodation device includes an air supply unit configured to introduce exterior air into the substrate accommodation device; an exhaust unit disposed to face the air supply unit; a substrate mounting plate that is provided between the air supply unit and the exhaust unit and provided with holes through which the air supply unit and the exhaust unit communicate with each other; an air supply filter provided at the air supply unit; and a fan provided at the air supply unit or the exhaust unit. Further, one of a state sensor configured to detect a state within the substrate accommodation device, a particle charging device, and a temperature controller or a combination of two or more thereof may be detachably provided at the substrate accommodation device.

In accordance with another aspect of the illustrative embodiment, there is provided a substrate accommodation device for accommodating a substrate therein. The substrate accommodation device includes an air supply unit having an inlet port through which a purge gas is introduced into the substrate accommodation device; an exhaust unit disposed to face the air supply unit; a substrate mounting plate that is provided between the air supply unit and the exhaust unit and provided with holes through which the air supply unit and the exhaust unit communicate with each other; and a fan provided at the air supply unit or the exhaust unit. Further, one of a state sensor configured to detect a state within the substrate accommodation device, a particle charging device, and a temperature controller or a combination of two or more thereof may be detachably provided at the substrate accommodation device.

In this configuration in accordance with the illustrative embodiment, the exterior air is introduced from the air supply unit through the filter by driving the fan. Further, the purge gas is introduced through the inlet port. Then, the introduced exterior air or the introduced purge gas is exhausted from the exhaust unit facing the air supply unit. Accordingly, an air flow from the air supply unit toward the exhaust unit is generated at a vicinity of the substrate accommodated between the air supply unit and the exhaust unit within the substrate accommodation device. Thus, for example, even if a minute foreign substance, which is not removed by the filter depending on the environment where the substrate accommodation device is used, is introduced from the air supply unit, it is possible to efficiently discharge the foreign substance through the exhaust unit. Hence, it is possible to prevent the foreign substance from adhering to the substrate within the substrate accommodation device.

Further, in accordance with the illustrative embodiment, one of the state sensor, the particle charging device, and the temperature controller or a combination of two or more thereof can be provided within the substrate accommodation device depending on the environment where the substrate accommodation device is used. Accordingly, it is possible to effectively prevent the foreign substance from adhering to the substrate in the substrate accommodation device depending on the environment, without waste in equipment.

Further, the state sensor may be, e.g., one of a temperature sensor, a charging sensor, a particle sensor, a vibration sensor, and a gas sensor or a combination of two or more thereof. Furthermore, the substrate accommodation device may include a storage unit configured to store therein data outputted from the state sensor; and a controller configured to determine whether the data stored in the storage unit exceed a threshold value. If the data stored in the state sensor exceed the threshold value, it indicates occurrence of abnormality, and it can be determined that abnormality occurs and the foreign substance adheres to the substrate accommodated within the substrate accommodation device.

Further, the substrate accommodation device may include an external housing for enclosing and accommodating the substrate accommodation device therein. Furthermore, a circulation path for returning air exhausted from the exhaust unit back into the air supply unit may be formed between the substrate accommodation device and the external housing. By way of example, vibration isolators may be provided between the substrate accommodation device and the external housing, and a space between the vibration isolators serves as the circulation path. In this configuration, since the air exhausted from the exhaust unit is returned back into the air supply unit through the circulation path, it is possible to transfer the substrate while the inside of the external housing is maintained clean in an environment other than, e.g., a clean room.

Further, a side plate may be detachably provided between the air supply unit and the exhaust unit. With this configuration, for example, by separating the side plate, the substrate can be loaded into and unloaded from the substrate accommodation device through a lateral side thereof by a transfer arm or the like.

In accordance with still another aspect of the illustrative embodiment, there is provided a substrate accommodation device for accommodating a substrate therein. The substrate accommodation device includes an air supply unit configured to introduce exterior air into the substrate accommodation device; an exhaust unit disposed to face the air supply unit; a substrate mounting plate that is provided between the air supply unit and the exhaust unit and provided with holes through which the air supply unit and the exhaust unit communicate with each other; and a fan provided at the air supply unit or the exhaust unit. Further, one of a state sensor configured to detect a state within the substrate accommodation device, a particle charging device, and a temperature controller configured to heat a surface of the substrate or a combination of two or more thereof may be detachably provided at the substrate accommodation device, and a space between the air supply unit and the exhaust unit may be opened.

In this configuration in accordance with the illustrative embodiment, the exterior air is introduced from the air supply unit through the filter by driving the fan, and then, is exhausted from the exhaust unit facing the air supply unit. Accordingly, the air flow from the air supply unit toward the exhaust unit is generated in the vicinity of the substrate accommodated within the substrate accommodation device. Thus, even if the foreign substance is introduced into the substrate accommodation device, it is possible to efficiently discharge the foreign substance. Further, while preventing the foreign substance from adhering to the substrate within the substrate accommodation device, it is possible to easily load or unload the substrate into or from the substrate accommodation device through the opened lateral side by a transfer arm or the like.

In accordance with the illustrative embodiment, one of the state sensor, the particle charging device, and the temperature controller or a combination of two or more thereof can be provided within the substrate accommodation device depending on the environment where the substrate accommodation device is used. Accordingly, it is possible to effectively prevent the foreign substance from adhering to the substrate in the substrate accommodation device depending on the environment, without waste in equipment.

The substrate accommodation device may include an external housing for enclosing and accommodating the substrate accommodation device therein. Further, a blocking plate for closing the opened space between the air supply unit and the exhaust unit may be provided in the external housing, and a circulation path for returning air exhausted from the exhaust unit back into the air supply unit may be provided between the substrate accommodation device and the external housing. In this case, vibration isolators may be provided between the substrate accommodation device and the external housing, and a space between the vibration isolators may serve as the circulation path. With this configuration, if the substrate accommodation device is accommodated in the external housing, the opened lateral side is closed by the blocking plate. Accordingly, the air within the substrate accommodation device can be exhausted through the exhaust unit and can be returned back into the air supply unit through the circulation path. Thus, it is possible to transfer the substrate while the inside of the external housing is maintained clean in an environment other than, e.g., a clean room.

Further, a vibration isolator may be provided at an outer side of the substrate accommodation device or at an outer side of the external housing. With this configuration, when the substrate is transferred in an environment other than, e.g., a clean room, vibration or the like can be absorbed. Thus, even if the foreign substance adheres to the inside of the substrate accommodation device, it is possible to prevent the foreign substance from falling off and adhering to the substrate.

### Effect of the Invention

In accordance with the illustrative embodiment, it is possible to effectively prevent a foreign substance from adhering to a substrate in the substrate accommodation device. Further, one of the state sensor, the particle charging unit, and the temperature controller or a combination of two or more thereof may be provided in the substrate accommodation device depending on the environment where the substrate accommodation device is used. Hence, it is possible to effectively prevent the foreign substance from adhering to a substrate in the substrate accommodation device depending on the environment, without waste in equipment.

### BRIEF DESCRIPTION OF THE DRAWINGS

FIG. 1 is a perspective view schematically illustrating a configuration of a substrate accommodation device in accordance with an illustrative embodiment.

FIG. 2 is a cross sectional view of the substrate accommodation device shown in FIG. 1.

FIG. 3 is a cross sectional view illustrating a configuration in which a state sensor is provided in the substrate processing device in accordance with the illustrative embodiment.

FIG. 4 is a cross sectional view illustrating a configuration in which a combination of a state sensor and a particle charging device is provided in the substrate processing device in accordance with the illustrative embodiment.

FIG. 5 is a cross sectional view illustrating a configuration in which a combination of the state sensor and a temperature controller is provided in the substrate processing device in accordance with the illustrative embodiment.

FIG. 6 is a perspective view illustrating an example of a vibration isolator provided in the substrate processing device shown in FIG. 1.

FIG. 7 is a perspective view illustrating a modification example of the vibration isolator shown in FIG. 6.

FIG. 8 is a cross sectional view illustrating a configuration in which the substrate processing device having the vibration isolator shown in FIG. 7 is accommodated in an external housing.

FIG. 9 is a cross sectional view illustrating a modification example of the substrate processing device in accordance with the illustrative embodiment.

FIG. 10 is a perspective view illustrating another modification example of the substrate processing device in accordance with the illustrative embodiment.

FIG. 11 is a perspective view illustrating an example of the vibration isolator provided in the substrate accommodation device shown FIG. 10.

FIG. 12 is a cross sectional view illustrating a configuration in which the substrate processing device having the vibration isolator shown in FIG. 11 is accommodated in the external housing.

### BEST MODE FOR CARRYING OUT THE INVENTION

Hereinafter, an illustrative embodiment will be described in detail with reference to the accompanying drawings. Through the specification and drawings, parts having substantially the same functions and configurations will be assigned the same reference numerals and redundant description thereof will be omitted.

(Configuration of Substrate Accommodation Device)

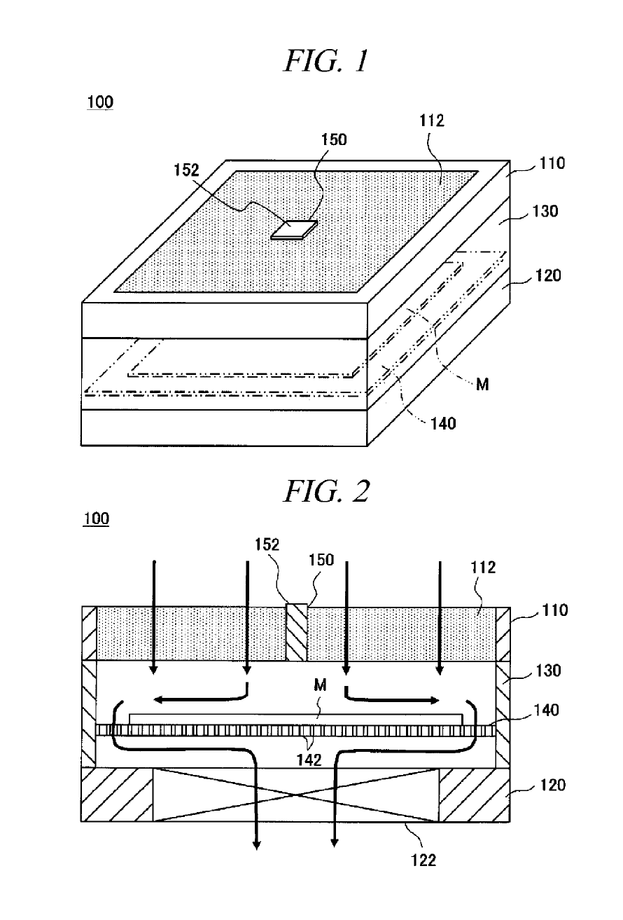

First, a substrate accommodation device in accordance with the illustrative embodiment will be described with reference to the accompanying drawings. Here, for example, the substrate accommodation device is configured to accommodate and transfer mask blanks as substrates one by one. FIG. 1 is a perspective view illustrating a configuration of the substrate accommodation device in accordance with the illustrative embodiment. FIG. 2 is a cross sectional view of the substrate accommodation device. As depicted in FIG. 1, the substrate accommodation device 100 has a box-shaped appearance and is configured to accommodate therein a single sheet of mask blank M horizontally.

The substrate accommodation device 100 includes an air supply unit 110 for introducing exterior air into the substrate accommodation device 100 and an exhaust unit 120 for exhausting an atmosphere within the substrate accommodation device 100. The exhaust unit 120 is provided so as to face the air supply unit 110. In FIG. 1, an upper portion of the substrate accommodation device 100 is configured as the air supply unit 110 and a lower portion of the substrate accommodation device 100 is configured as the exhaust unit 120. Further, the configuration of the air supply unit 110 and the exhaust unit 120 may not be limited thereto. By way of example, the air supply unit 110 and the exhaust unit 120 may be provided at parts of the upper portion and the lower portion of the substrate accommodation device 100, respectively. A sidewall 130 is provided between the air supply unit 110 and the exhaust unit 120 to hermetically surround the side portion of the substrate accommodation device 100.

As illustrated in FIG. 2, the air supply unit 110 includes an air supply filter 112 for filtering the exterior air introduced into the substrate accommodation device 100. By introducing the exterior air after removing foreign substances contained in the exterior air through the air supply filter 112, it is possible to prevent the foreign substances from adhering to the mask blank M within the substrate accommodation device 100.

Such an air supply filter 112 may be formed of, but not limited to, a particle removing filter for removing particles such as dust or wastes in the exterior air. The particle removing filter may be, e.g., a HEPA (High Efficiency Particulate Air) filter or a ULPA (Ultra Low Penetration Air) filter.

The exhaust unit 120 includes a fan 122 for exhausting an atmosphere within the substrate accommodation device 100. In FIG. 2, there is provided an example configuration where the single fan 122 is provided at a central portion of the exhaust unit 120. However, the number of the fan 122 is not limited thereto, and more than one fan 122 may be provided. Further, the fan 122 may be provided at the air supply unit 110. In such case, the fan 122 may be positioned above or below the air supply filter 112.

Within the substrate accommodation device 100, a substrate mounting plate 140 is provided between the air supply unit 110 and the exhaust unit 120. The mask blank M is mounted on the substrate mounting plate 140.

The substrate mounting plate 140 is configured to partition the inside of the substrate accommodation device 100 into a space at a side of the air supply unit 110 and a space at a side of the exhaust unit 120. The substrate mounting plate 140 is provided with holes 142 through which the space at the side of the air supply unit 110 and the space at the side of the exhaust unit 120 communicate with each other.

In the substrate accommodation device 100 having the aforementioned configuration, if the fan 122 of the exhaust unit 120 is driven, the exterior air is introduced from the air supply unit 110, and then, is exhausted from the exhaust unit 120 through the holes 142 of the substrate mounting plate 140 as illustrated in FIG. 2. Accordingly, an air flow from the air supply unit 110 at the upper portion of the substrate accommodation device 100 toward the exhaust unit 120 at the lower portion thereof is generated within the substrate accommodation device 100. Thus, the air flow discharged from the air supply unit 110 is generated on the mask blank M mounted on the substrate mounting plate 140.

In this configuration, since the exterior air is introduced through the air supply filter 112, most of foreign substances are removed by the air supply filter 112 and may not be introduced into the substrate accommodation device 100. However, depending on an environment where the substrate accommodation device 100 is used, the exterior air may contain the minute foreign substance that cannot be removed even by the air supply filter 112.

In this case, since the air flow from the air supply unit 110 toward the exhaust unit 120 is generated within the substrate accommodation device 100, the foreign substances, if any, that may not be removed by the air supply filter 112 and introduced into the substrate accommodation device 100 may also be discharged through the exhaust unit 120 along with the air flow. Since the minute foreign substances have very light weight, the foreign substances may not adhere to the mask blank M mounted on the substrate mounting plate 140 but may be discharged through the exhaust unit 120. Thus, regardless of the size of the foreign substance contained in the exterior air, it is possible to effectively prevent the foreign substance from adhering to the mask blank M within the substrate accommodation device 100.

Depending on the environment where the substrate accommodation device 100 is used, however, it may not be sufficient for preventing the foreign substances from adhering to the mask blank M just by generating the air flow within the substrate accommodation device 100. For example, if the foreign substances are electrically charged or a great amount of foreign substances are introduced, even though their sizes are small, such foreign substances are highly likely to adhere to the mask blank M.

To solve this problem, in the substrate accommodation device 100 in accordance with the illustrative embodiment, one of a state sensor configured to detect a state within the substrate accommodation device 100, a particle charging device, and a temperature controller or a combination of two or more thereof may be detachably provided in the substrate accommodation device 100. With this configuration, the substrate accommodation device 100 is allowed to provide an optimum function depending on the environment where the substrate accommodation device 100 is used.

By way of example, by providing the state sensor and detecting a state within the substrate accommodation device 100, it can be determined whether the inside of the substrate accommodation device 100 is in an environment where adhesion of foreign substances easily occurs. Further, by providing the particle charging device in the substrate accommodation device 100, and by removing the electric charges of the foreign substances and the mask blank M or controlling the polarity of the electrically charged foreign substance and mask blank M, it is possible to make it difficult for the foreign substances to adhere to the mask blank M.

Furthermore, minute foreign substances tend to be gathered to a region having a lower temperature if a temperature difference is generated. Therefore, by providing the temperature controller in the substrate accommodation device 100 and controlling the temperature of the mask blank M and a vicinity thereof, it is possible to make it difficult for the foreign substances to adhere to the mask blank M. Further, by combining the state sensor, the particle charging device, and the temperature controller, it is possible to make it more difficult for the foreign substance to adhere to the mask blank M. In this way, the state sensor, the particle charging device, and the temperature controller can be appropriately selected and provided depending on the environment where the substrate accommodation device 100 is used. Accordingly, it is possible to effectively prevent the foreign substance from adhering to the mask blank M depending on the environment where the substrate accommodation device 100 is used, without waste in equipment.

(Specific Example of Substrate Processing Device)

Now, a specific example of the substrate accommodation device 100 including the aforementioned state sensor, particle charging device, and/or temperature controller will be described. By way of example, as depicted in FIG. 1, in the substrate accommodation device 100 in accordance with the illustrative embodiment, a mounting hole 150 is formed in the air supply unit 110. By fitting a mounting member 152 at which the state sensor, the particle charging device, or the temperature controller is provided into the mounting hole 150, the state sensor, the particle charging device, or the temperature controller can be detachably provided in the substrate accommodation device 100.

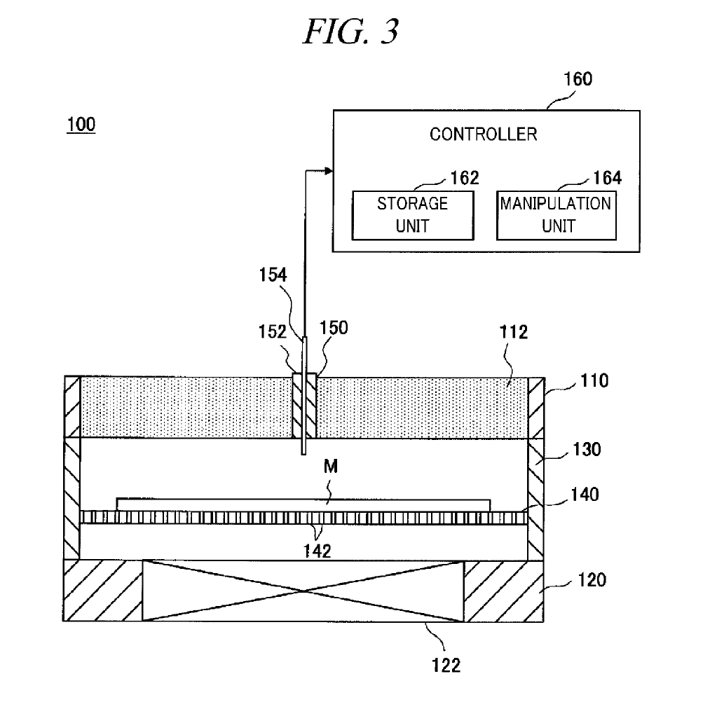

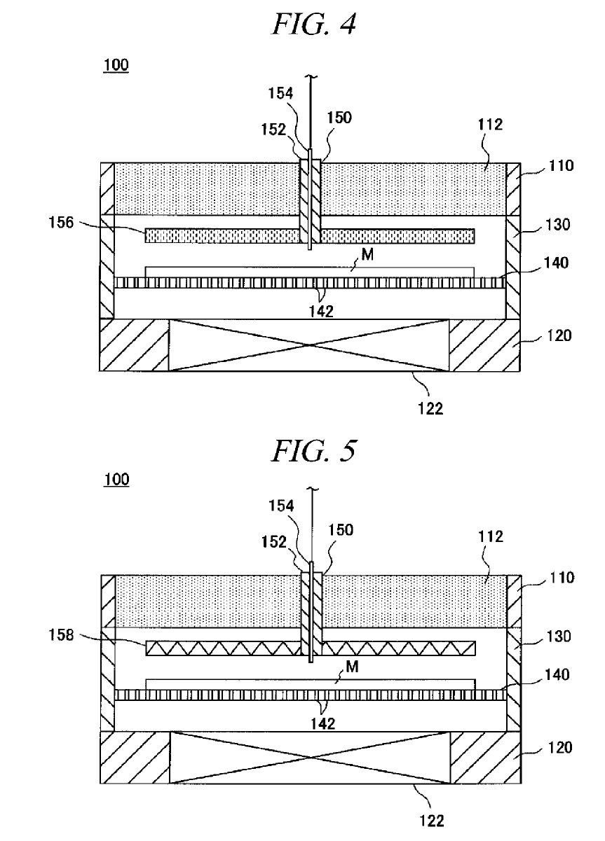

Configuration examples in which the state sensor, the particle charging device, and/or the temperature controller is provided will be explained in further detail with reference to the accompanying drawings. FIG. 3 is a cross sectional view illustrating a configuration example in which only a state sensor 154 is provided. FIG. 4 is a cross sectional view illustrating a configuration example in which a combination of the state sensor 154 and a particle charging device 156 is provided. FIG. 5 is a cross sectional view illustrating a configuration example in which a combination of the state sensor 154 and a temperature controller 158 is provided.

First, the configuration example including only the state sensor 154 will be explained with reference to FIG. 3. By fitting the mounting member 152 at which the state sensor 154 is provided into the mounting hole 150, the state sensor 154 is provided in the substrate accommodation device 100. The state sensor 154 detects an internal state (e.g., a temperature, a charging degree, a mixing ratio of the foreign substances, etc.) within the substrate accommodation device 100. The state sensor 154 may be, but not limited to, a temperature sensor, a charging sensor, a particle sensor, a vibration sensor, a gas sensor, or the like. These sensors may be provided individually or a combination of two or more thereof may be provided.

The temperature sensor may detect a temperature within the substrate accommodation device 100, a temperature of the mask blank M, and so forth. The charging sensor may detect the polarity of the electrically charged foreign substances and the polarity of the mask blank M within the substrate accommodation device 100 and also detects the charging degree thereof. The particle sensor may detect the amount of foreign substances within the substrate accommodation device 100. The vibration sensor may detect both strong and weak vibrations. In order to detect the strong vibration, an acceleration sensor may be used as the vibration sensor, and in order to detect the weak vibration, an ultrasonic sensor may be used.

The state sensor 154 is connected with a controller 160 configured to control the entire operations of the substrate accommodation device 100. The controller 160 includes a storage unit 162, a manipulation unit 164, and so forth. The storage unit 162 stores therein, e.g., data detected from the state sensor 154. The manipulation unit 164 includes a power switch and so forth.

Based on an output from the state sensor 154, the controller 160 determines whether a foreign substance adheres to the mask blank M within the substrate accommodation device 100 and also determines the environment where the substrate accommodation device 100 is used. By way of example, if there is a state change within the substrate accommodation device 100, such as a variation in the temperature or the charging degree, a foreign substance may easily adhere to the mask blank M. Accordingly, by monitoring the internal state and detecting the variation in the internal state, it can be determined whether or not a foreign substance adheres to the mask blank M.

To elaborate, if data outputted from the state sensor 154 are inputted to the controller 160, the controller 160 stores the data in the storage unit 162 and monitors the internal state within the substrate accommodation device 100. If the data outputted from the state sensor 154 exceeds a certain threshold value, the controller 160 determines that a foreign substance adheres to the mask blank M.

Furthermore, based on the data outputted from the state sensor 154, the controller 160 determines the environment where the substrate accommodation device 100 is used (for example, whether the environment is where foreign substances are electrically charged or where a great amount of foreign substances are introduced, etc.). Based on the determination result, the controller 160 determines whether or not to provide, e.g., the particle charging device 156 or the temperature controller 158. If it is determined to provide these devices, the controller 160 also determines which one of the devices or which combination thereof will be provided. By way of example, in an environment where foreign substances are electrically charged, the controller 160 determines that the particle charging device 156 needs to be provided. Meanwhile, in an environment where the great amount of the foreign substances are introduced, the controller 160 determines that the temperature controller 158 needs to be provided. Further, such determination may not be automatically made, but an operator of the substrate accommodation device 100 may make a decision based on the determination result of the environment where the substrate accommodation device 100 is used.

Now, referring to FIG. 4, there will be explained a configuration example in which the combination of the state sensor 154 and the particle charging device 156 is provided. The particle charging device 156 is provided at the mounting member 152 so as to be located above the mask blank M while spaced apart from the air supply filter 112. The state sensor 154 is also provided at the mounting member 152. With this configuration, by fitting the mounting member 152 into the mounting hole 150, both of the state sensor 154 and the particle charging device 156 can be provided in the substrate accommodation device 100.

The particle charging device 156 may be formed of, but not limited to, a soft X-ray source, a UV light source, an ionizer, or the like. By removing the electric charges within the substrate accommodation device 100 through the particle charging device 156, electric charges of foreign substances that have been introduced into the substrate accommodation device 100 can be removed. As a result, it is possible to effectively prevent the foreign substance from adhering to the mask blank M.

Furthermore, by generating ions by the ionizer, the foreign substances may be electrically charged to have the same polarity as that of the mask blank M. As a result, it is possible to effectively prevent the foreign substance from adhering to the mask blank M. Further, in this case, it may be possible to apply a voltage having the same polarity as that of the foreign substance from below the mask blank M. Moreover, the state sensor 154 may be formed of a charging sensor, and the controller 160 may detect the charging degree. Then, the controller 160 may control an output of the particle charging device 156 based on the detection result.

Now, referring to FIG. 5, there will be explained a configuration example in which the combination of the state sensor 154 and the temperature controller 158 is provided. The temperature controller 158 is provided at the mounting member 152 so as to be located above the mask blank M while spaced apart from the air supply filter 112. The state sensor 154 is also provided at the mounting member 152. With this configuration, by fitting the mounting member 152 into the mounting hole 150, both of the state sensor 154 and the temperature controller 158 can be provided in the substrate accommodation device 100.

The temperature controller 158 may be formed of a heater, a heating lamp, or the like. The temperature controller 158 is configured to control a surface temperature of the mask blank M to be higher than an ambient temperature. As a result, a temperature difference therebetween may be generated. Accordingly, a thermophoretic force is applied to the foreign substances in the vicinity of the surface of the mask blank M in a direction away from the surface of the mask blank M. Further, the thermophoretic force applied to the foreign substances increases as the foreign substances approach the surface of the mask blank M. Thus, it may become more difficult for the foreign substances to adhere to the surface of the mask blank M. Desirably, the temperature difference may be set to be at least about 5° C. and, more desirably, at least about 15° C. The temperature difference may have a range (e.g., about 500° C.) where the mask blank M is not melted.

Further, the temperature controller 158 may be formed of a cooling unit. With this configuration, by setting the temperature of the rear surface of the mask blank M and the vicinity thereof to be lower than the temperature of the front surface of the mask blank M, a temperature difference may be generated such that the temperature of the front surface of the mask blank M becomes relatively higher. Further, the state sensor 154 may be formed of a temperature sensor. With this configuration, the controller 160 may detect a temperature and control the instruction temperature of the temperature controller 158 based on the detection result.

As stated above, in the substrate accommodation device 100 in accordance with the illustrative embodiment, at least one of the state sensor 154, the particle charging device 156, and the temperature controller 158 or a combination of two or more thereof may be detachably provided. Accordingly, it is possible to effectively prevent the adhesion of foreign substances appropriately and securely depending on the environment where the substrate accommodation device 100 is used, without waste in equipment.

Various processes such as a film formation, a CMP (Chemical Mechanical polishing), and a cleaning are repeatedly performed on the surface of a glass substrate serving as a base of the mask blank M accommodated in the substrate accommodation device 100. As a result, a circuit pattern is formed, and a photomask having the circuit pattern thereon is obtained.

Since these processes such as the film formation and the CMP are performed in respective apparatuses, the mask blank M needs to be transferred between the respective apparatuses. At this time, if the foreign substance adheres to the surface of the mask blank M while the mask blank M is being transferred or stored, a defect (foreign substance itself or a flaw caused by the foreign substance) may be generated in a subsequent process. For example, if the process such as a film formation is performed under the circumstance where the foreign substance adheres to the surface of the mask blank M, generated films may be distorted due to the defect, so that a phase defect or the like may occur. As a result, a photomask having the defect by the foreign substance itself or flaw caused by the foreign substance may be fabricated.

To solve this problem, when transferring or storing the mask blank M, the mask blank M needs to be accommodated in the substrate accommodation device 100 in accordance with the illustrative embodiment. For the environment of, e.g., a clean room, where this substrate accommodation device 100 is used, at least one of the state sensor 154, the particle charging device 156, and the temperature controller 158 or a combination of two or more thereof may be selectively provided. Accordingly, it is possible to effectively prevent adhesion of foreign substances appropriately and securely depending on the environment of the clean room, without waste in equipment.

Further, recently, lithography technology using EUV (Extreme Ultra-Violet) is attracting attention as a next-generation lithography technology. The EUV is an extreme ultraviolet ray having a wavelength of about 13 nanometers. With the EUV, a pattern of an extremely fine circuit width as small as about 50 nanometers or less can be formed. Thus, an extremely minute foreign substance in the order of, e.g., from about several tens of nanometers to more than ten and less than twenty nanometers adheres to the mask blank M to be used in this lithography technology, an adverse effect may be provided on the subsequent process.

It is possible to prevent such an extremely minute foreign substance from adhering to the mask blank M by electrically charging the foreign substance or controlling the temperature thereof. Thus, it may be very effective to transfer and store the mask blank M by using the substrate accommodation device 100 in accordance with the illustrative embodiment. Moreover, in accordance with the substrate accommodation device 100, since the charging or the temperature control can be performed appropriately depending on the environment where the substrate accommodation device 100 is used, the effect of preventing adhesion of the foreign substances can be more improved.

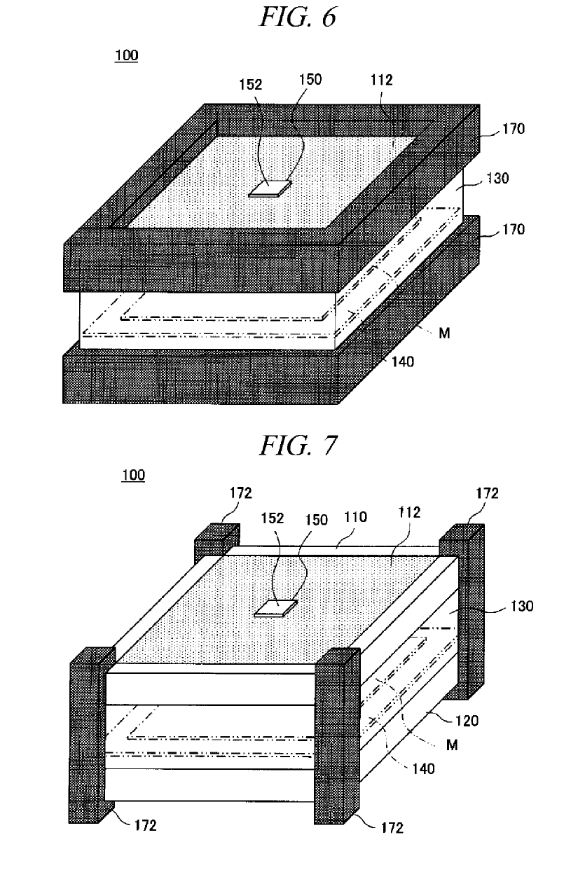

In addition, a vibration isolator may be provided in the substrate accommodation device 100 so as to prevent vibration. With this configuration, when the foreign substances adhere to the inside of the substrate accommodation device 100, it is possible to prevent the foreign substances from falling off due to the vibration generated when the substrate accommodation device 100 is transferred and from adhering to the surface of the mask blank M. To elaborate, as illustrated in FIG. 6, vibration isolators 170 are provided at both of the outer peripheries of the air supply unit 110 and the exhaust unit 120. The shapes and the arrangement positions of the vibration isolators 170 may not be limited to the shown example. By way of non-limiting example, as illustrated in FIG. 7, vibration isolators 172 extended from the air supply unit 110 to the exhaust unit 120 may be provided at each of the four corners of the substrate accommodation device 100.

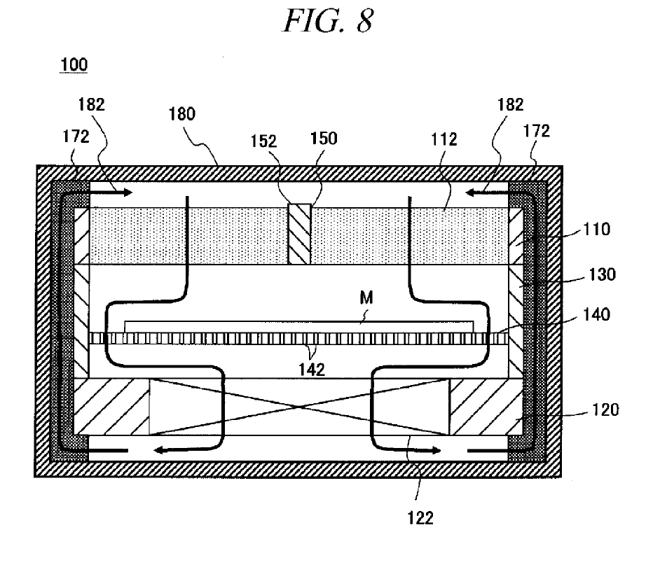

Furthermore, an external housing for accommodating therein the substrate accommodation device 100 may be provided. With this configuration, for example, when taking the substrate accommodation device 100 out of the clean room and loading it onto a truck or the like, it is possible to effectively prevent the foreign substances from adhering to the mask blank M. To be specific, there may be provided an external housing 180 for enclosing and accommodating therein the substrate accommodation device 100, as depicted in FIG. 8.

In this configuration, by accommodating the substrate accommodation device 100 with the vibration isolators into the external housing 180, a vibration removing effect can be more improved when the external housing 180 is transferred. Further, the vibration isolators need not necessarily be provided at an inside of the external housing 180 but may be provided at an outside of the external housing 180. Moreover, the vibration isolators may be provided at both of the inside and the outside of the external housing 180.

Moreover, if a vibration isolation sensor is provided as the state sensor 154 so as to detect vibration, generation of a strong vibration can also be detected. When transferring the external housing 180, as the vibration becomes stronger, foreign substances adhering to the inside of the substrate accommodation device 100 are more likely to fall off and adhere to the mask blank M. To solve this problem, for example, by monitoring the vibration isolation sensor, if a strong vibration exceeding a certain threshold value is generated, it may be determined that foreign substances have adhered to the mask blank M.

Desirably, a circulation path 182 for returning the air exhausted from the exhaust unit 120 back into the air supply unit 110 may be formed between the substrate accommodation device 100 and the external housing 180. FIG. 8 illustrates a specific configuration example in which the vibration isolators 172 illustrated in FIG. 7 are provided between the substrate accommodation device 100 and the external housing 180, and spaces between the vibration isolators 172 serve as circulation paths 182. In this configuration, since the air flow is generated in the substrate accommodation device 100, it is possible to effectively prevent the foreign substances from adhering to the mask blank M during the transfer of, e.g., the external housing 180. Further, even if the foreign substance is introduced into the external housing 180, the foreign substance is circulated through the circulation paths 182 and removed by the air supply filter 112. Thus, the inside of the external housing 180 can be maintained clean.

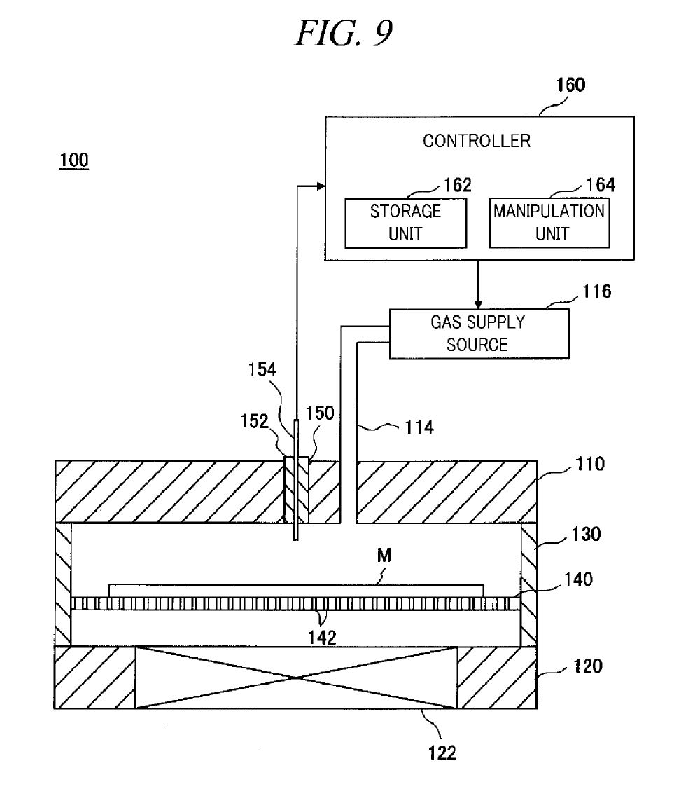

In the above-described illustrative embodiment, the air supply unit 110 has the air supply filter 112, and the exterior air is introduced through the air supply filter 112. However, it may be possible to provide an inlet port for introducing a purge gas into the air supply unit 110 instead of providing the air supply filter 112. In this configuration, instead of introducing the exterior air into the substrate accommodation device 100, a purge gas such as dry air or a nitrogen gas may be introduced through the inlet port. To elaborate, as depicted in FIG. 9, an inlet port 114 may be provided in the air supply unit 110, and a gas supply source 116 for supplying a purge gas is connected to the inlet port 114. The purge gas from the gas supply source 116 is introduced through the inlet port 114. As a result, a flow of a gas that is cleaner than the exterior air can be generated within the substrate accommodation device 100.

Further, in the above-described illustrative embodiment, although the sidewall 130 between the air supply unit 110 and the exhaust unit 120 is hermetically provided, the illustrative embodiment may not be limited thereto. By way of example, the sidewall 130 may be provided detachably or may be provided so as to be opened and closed. If the sidewall 130 is opened and closed, the mask blank M can be loaded into or unloaded from the substrate accommodation device 100 through the lateral sides of the substrate accommodation device 100 by a non-illustrated transfer arm or the like. Further, the sidewall 130 may be provided at only a part of four lateral sides of the substrate accommodation device 100. Further, the sidewall 130 may not be provided at all of the four lateral sides thereof.

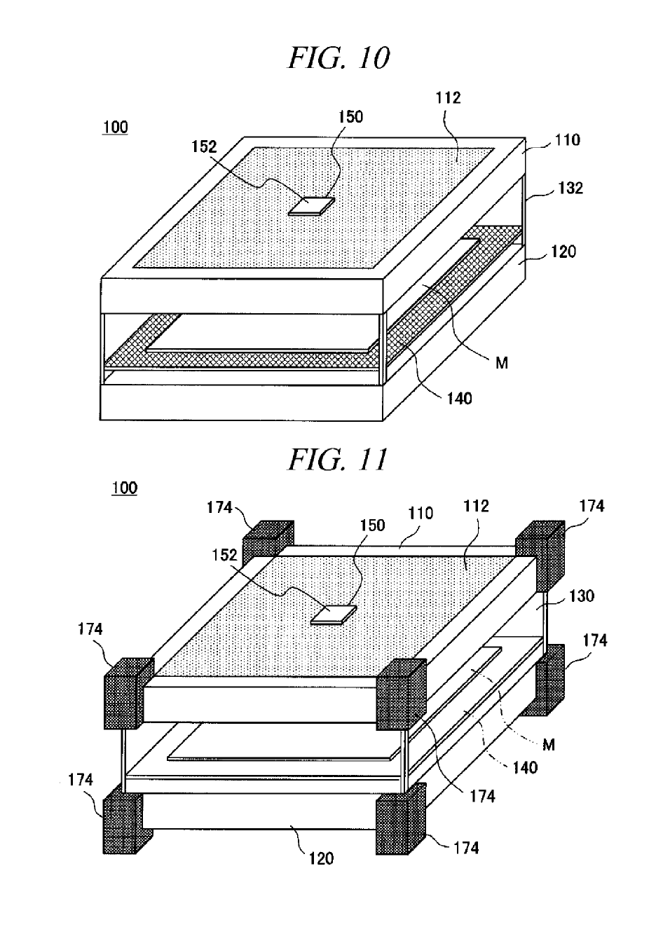

For example, as illustrated in FIG. 10, the sidewall 130 may not be provided at all of the four lateral sides of the substrate accommodation device 100. In this case, four corners of each of the air supply unit 110 and the exhaust unit 120 are supported by supporting members 132, and the lateral sides of the substrate accommodation device 100 are opened. With this configuration, the mask blank M can be more easily loaded into or unloaded from the substrate accommodation device 100 through the opened lateral sides by a non-illustrated transfer arm or the like.

Furthermore, in this configuration, if the fan 122 is driven, the exterior air is introduced not only through the air supply filter 112 but also through the opened lateral sides. In this case, however, since the air flow toward the exhaust unit 120 is generated, it is possible to prevent the foreign substance from adhering to the mask blank M. Further, the mounting hole 150 shown in FIG. 1 may also be formed in this substrate accommodation device 100 of FIG. 10, and at least one of the state sensor 154, the particle charging device 156, and the temperature controller 158 or a combination of two or more thereof may be detachably provided. Accordingly, it is possible to provide the optimum function depending on the environment where the substrate accommodation device 100 is used. Thus, even if the foreign substance is introduced into the substrate accommodation device 100 through the opened lateral sides along with the exterior air, it is possible to effectively prevent the foreign substance from adhering to the mask blank M.

In the substrate accommodation device 100 shown in FIG. 10, a vibration isolator may also be provided at the outer side thereof. For example, the vibration isolators 170 shown in FIG. 6 may be provided or the vibration isolators 172 shown in FIG. 7 may be provided. In addition, as depicted in FIG. 11, vibration isolators 174 may be provided at the four corners of each of the air supply unit 110 and the exhaust unit 120.

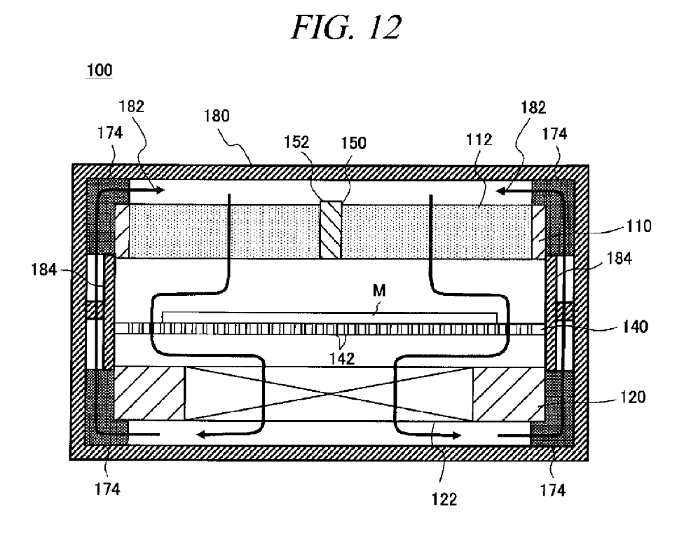

Moreover, in the substrate accommodation device 100 shown in FIG. 10, the external housing for accommodating the substrate accommodation device 100 may also be provided. With this configuration, for example, when taking the substrate accommodation device 100 out of the clean room and transferring it onto a truck or the like, it is possible to effectively prevent the foreign substance from adhering to the mask blank M. To be specific, there may be provided the external housing 180 for enclosing and accommodating therein the substrate accommodation device 100, as depicted in FIG. 12.

In this configuration, by accommodating the substrate accommodation device 100 with the vibration isolators 174 in the external housing 180, the vibration isolation effect can be more improved when the external housing 180 is transferred. In this case, the external housing 180 may be provided with blocking plates 184 for closing the opened lateral sides of the substrate accommodation device 100 when the substrate accommodation device 100 is accommodated in the external housing 180. Further, the circulation path 182 for returning the air exhausted from the exhaust unit 120 back into the air supply unit 110 may be formed between the substrate accommodation device 100 and the external housing 180. FIG. 12 illustrates a configuration example in which the vibration isolators 174 shown in FIG. 11 are provided between the substrate accommodation device 100 and the external housing 180 and in which spaces between the vibration isolators 174 and outside the blocking plates 184 are formed as circulation paths 182.

As in this configuration example, by closing the opened lateral sides of the substrate accommodation device 100 with the blocking plates 184, it is possible to prevent the air flow from being introduced through the opened lateral sides thereof. Accordingly, since the air flow from the exhaust unit 120 back into the air supply unit 110 is constantly generated within the substrate accommodation device 100, even if the foreign substance enters into the external housing 180, the foreign substance is circulated through the circulation paths 182 and removed by the air supply filter 112. Thus, the inside of the external housing 180 can be maintained clean. Further, the structure in which the state sensor 154, the particle charging device 156, and the temperature controller 158 are detachably provided may not be limited to the examples described in the illustrative embodiment.

While various aspects and embodiments have been described herein, other aspects and embodiments will be apparent to those skilled in the art. The various aspects and embodiments described herein are for the purposes of illustration and are not intended to be limiting. Therefore, the true scope of the disclosure is indicated by the appended claims rather than by the foregoing description, and it shall be understood that all modifications and embodiments conceived from the meaning and scope of the claims and their equivalents are included in the scope of the disclosure.

By way of example, the above illustrative embodiment has been described for the substrate accommodation device for accommodating a mask blank therein. However, the illustrative embodiment is not limited thereto and may also be applicable to a substrate accommodation device for accommodating various types of substrates such as a semiconductor wafer, a substrate for a FPD and a substrate for a photomask.

### INDUSTRIAL APPLICABILITY

The illustrative embodiment is applicable to a substrate accommodation device for accommodating a substrate such as a mask blank therein and transferring the substrate.

### EXPLANATION OF CODES

100: Substrate accommodation device
110: Air supply unit
112: Air supply filter
114: Inlet port
116: Gas supply source
120: Exhaust unit
122: Fan
130: Sidewall
132: Supporting member
140: Substrate mounting plate
142: Hole
150: Mounting hole
152: Mounting member
154: State sensor
156: Particle charging device
158: Temperature controller
160: Controller
162: Storage unit
164: Manipulation unit
170, 172, 174: Vibration isolator
180: External housing
182: Circulation path
184: Blocking plate
M: Mask blank

1. A substrate accommodation device for accommodating a substrate therein, the substrate accommodation device comprising:
an air supply unit configured to introduce exterior air into the substrate accommodation device;
an exhaust unit disposed to face the air supply unit;
a substrate mounting plate that is provided between the air supply unit and the exhaust unit and provided with holes through which the air supply unit and the exhaust unit communicate with each other;
an air supply filter provided at the air supply unit; and
a fan provided at the air supply unit or the exhaust unit,
wherein one of a state sensor configured to detect a state within the substrate accommodation device, a particle charging device, and a temperature controller or a combination of two or more thereof is detachably provided at the substrate accommodation device.

2. The substrate accommodation device of claim 1,
wherein the state sensor is one of a temperature sensor, a charging sensor, a particle sensor, a vibration sensor, and a gas sensor or a combination of two or more thereof.

3. The substrate accommodation device of claim 1, further comprising:
a storage unit configured to store therein data outputted from the state sensor; and
a controller configured to determine whether the data stored in the storage unit exceed a threshold value.

4. The substrate accommodation device of claim 1, further comprising:
an external housing for enclosing and accommodating the substrate accommodation device therein,
wherein a circulation path for returning air exhausted from the exhaust unit back into the air supply unit is formed between the substrate accommodation device and the external housing.

5. The substrate accommodation device of claim 4,
wherein vibration isolators are provided between the substrate accommodation device and the external housing, and a space between the vibration isolators serves as the circulation path.

6. The substrate accommodation device of claim 4,
wherein a vibration isolator is provided at an outer side of the substrate accommodation device or at an outer side of the external housing.

7. The substrate accommodation device of claim 6,
wherein a side plate is detachably provided between the air supply unit and the exhaust unit.

8. A substrate accommodation device for accommodating a substrate therein, the substrate accommodation device comprising:
an air supply unit having an inlet port through which a purge gas is introduced into the substrate accommodation device;
an exhaust unit disposed to face the air supply unit;
a substrate mounting plate that is provided between the air supply unit and the exhaust unit and provided with holes through which the air supply unit and the exhaust unit communicate with each other; and
a fan provided at the air supply unit or the exhaust unit,
wherein one of a state sensor configured to detect a state within the substrate accommodation device, a particle charging device, and a temperature controller or a combination of two or more thereof is detachably provided at the substrate accommodation device.

9. A substrate accommodation device for accommodating a substrate therein, the substrate accommodation device comprising:
an air supply unit configured to introduce exterior air into the substrate accommodation device;
an exhaust unit disposed to face the air supply unit;
a substrate mounting plate that is provided between the air supply unit and the exhaust unit and provided with holes through which the air supply unit and the exhaust unit communicate with each other; and
a fan provided at the air supply unit or the exhaust unit,
wherein one of a state sensor configured to detect a state within the substrate accommodation device, a particle charging device, and a temperature controller or a combination of two or more thereof is detachably provided at the substrate accommodation device, and
a space between the air supply unit and the exhaust unit is opened.

10. The substrate accommodation device of claim 9, further comprising:
an external housing for enclosing and accommodating the substrate accommodation device therein,
wherein a blocking plate for closing the opened space between the air supply unit and the exhaust unit is provided in the external housing, and
a circulation path for returning air exhausted from the exhaust unit back into the air supply unit is provided between the substrate accommodation device and the external housing.

11. The substrate accommodation device of claim 10,
wherein vibration isolators are provided between the substrate accommodation device and the external housing, and a space between the vibration isolators serves as the circulation path.

12. The substrate accommodation device of claim 10,
wherein a vibration isolator is provided at an outer side of the substrate accommodation device or at an outer side of the external housing.
